(19) United States
(12) Patent Application Publication
(10) Pub. No.: US 2024/0070603 A1
(43) Pub. Date: Feb. 29, 2024

(54) LOCATION PLANNING USING ISOCHRONES COMPUTED FOR CANDIDATE LOCATIONS

(71) Applicant: Maplebear Inc. (dba Instacart), San Francisco, CA (US)

(72) Inventors: Jagannath Putrevu, Daly City, CA (US); Haochen Luo, Conroe, TX (US); Xiangpeng Li, Redmond, WA (US); Rishab Saraf, Redmond, WA (US)

(21) Appl. No.: 17/899,977

(22) Filed: Aug. 31, 2022

(51) Int. Cl. G06Q 10/08; G06F 16/29; G06Q 30/02

(52) U.S. Cl. CPC G06Q 10/08355; G06F 16/29; G06Q 30/0205

(57) ABSTRACT

A grid is created for a map of a geographic region based on a location planning request received from a user device. A plurality of candidate cells are identified from among a plurality of cells of the grid. Each of the candidate cells including a candidate location for a warehouse. Respective isochrones are generated relative to the candidate locations of the plurality of candidate cells based on a delivery time threshold indicated in the location planning request. Respective isochrone scores are determined for the generated isochrones based at least on data indicating a past volume of sales in the isochrone. Based on the respective isochrone scores of the candidate locations, a subset of the candidate locations is selected as a recommended set of locations for warehouses to cover the geographic region. A notification indicating the recommended set of locations is transmitted to the user device.

### BACKGROUND

Order delivery systems dispatch pickers to travel to warehouses (e.g., retail stores, fulfilment centers, dark stores, and the like) to pick customer's orders and deliver them to customers. Some order delivery systems may provide ultrafast delivery services to customers where deliveries of orders to customers in a particular geographic region (e.g., a given metropolitan area) is guaranteed within a predetermined time period (e.g., 15-minute delivery, 30-minute delivery, 2-hour delivery, and the like). In order to provide the ultrafast delivery services with high customer satisfaction, it is imperative for the order delivery system to setup warehouse locations throughout the geographic region where the ultrafast delivery service is being offered, so that an order from any customer in any part of the geographic region can be fulfilled by a picker from a nearby warehouse location and delivered to the customer within the predetermined time period. However, setting up each new warehouse location involves significant capital expenditures, and requires continuous operational and maintenance costs.

### SUMMARY

This disclosure relates generally to location planning, and more specifically, to identifying a set of warehouse locations in a geographic region based on isochrones computed for respective candidate locations. That is, this disclosure pertains to identifying a set of geographic locations corresponding to a geographic region (e.g., a metropolitan area) that may allow an online concierge system to provide an ultrafast delivery service where deliveries of orders to customers in the geographic region is guaranteed within a predetermined time period (e.g., 15-minute delivery, 30-minute delivery, 2-hour delivery, and the like). Techniques disclosed herein look to identify the set of locations based on a location planning request received from a user device (e.g., device associated with a member of a real estate team of the online concierge system). The location planning request may set the objectives of the location planning and identify elements like the geographic area where the ultrafast delivery service is to be offered, the delivery time threshold of the ultrafast delivery service, characteristics of each warehouse location (e.g., size, square footage, budget, and the like), and the like. Based on the location planning request, the system may provide a recommended set of locations that meets the objectives of the request.

More specifically, based on the request, the system may access a map of the specified geographic region, divide the region into subunits or cells by creating or overlaying a grid including multiple cells on the map, where one or more of the cells may include candidate locations for warehouses. To determine whether a given cell includes a candidate location for a warehouse, the system may access characteristics of the cell (e.g., population data, demographic data, map data (e.g., cell includes geographic features like a lake, a public park, an airport, a river, and the like), zoning data of the cell, and the like), characteristics of the warehouse (e.g., size, square footage, budget, and the like), and other data (e.g., data from a database listing available warehouse locations). The candidate location in a given cell may be a representative location at the center of the cell or another location in the cell (e.g., a location corresponding to an actual available warehouse location identified as matching or otherwise satisfying the warehouse characteristics included in the location planning request). Based on the determination, the system may identify as candidate cells from among the plurality of cells, the cells that respectively include candidate locations for warehouses.

The system may then generate isochrones for each of the plurality of candidate cells based on the candidate location in the cell and based on the delivery time threshold included in the location planning request. The isochrones may be computed using a machine-learning model that is trained to predict travel time between any two locations in the geographic region based on order data. The system may further assign isochrone scores to each of the computed isochrones based on various factors (e.g., order data indicating past sales volume (e.g., number of orders, size of orders, order activity) within the isochrone, a forecast output by a machine-learning model indicating future sales volume in the isochrone, population or demographic data of the isochrone, and the like). For example, a higher isochrone score (e.g., based on higher past sales volume) for a given isochrone may indicate that the corresponding candidate location is a preferable location for setting up a new warehouse.

Based on the isochrone scores, the system may select a set of isochrones to cover the geographic region of the location planning request such that isochrones with the highest scores are selected while overlap between the selected isochrones is minimized (e.g., double counting of the same customers (based on which the respective isochrone scores are determined) in the overlapping isochrones is minimized). In selecting the set of isochrones, the system further determines for each additional isochrone selected to be included in the set, whether the marginal cost of the warehouse location corresponding to the additional isochrone is justified by its marginal benefit (e.g., profitability value of the warehouse location corresponding to the additional isochrone). Thus, for example, for a first geographic region of a first location planning request, the system may ultimately recommend a set of locations that provide a 40% coverage of the geographic region as a whole, whereas in a second geographic region of a second location planning request, the system may ultimately recommend a set of locations that provide a 90% coverage of the second geographic region. Finally, the system may transmit the locations corresponding to the selected set of isochrones as a recommended set of locations for setting up warehouses in response to the location planning request received from the user device.

In one or more embodiments, a computer-implemented method includes a plurality of steps. In particular, the method includes a step of accessing a map of a geographic region based on a location planning request received from a user device. The location planning request includes an indication of the geographic region and a delivery time threshold. The method further includes a step of creating a grid for the map of the geographic region, the grid defining a plurality of cells. Still further, the method includes a step of identifying a plurality of candidate cells from among the plurality of cells, each of the plurality of candidate cells including a candidate location for a warehouse. Yet still further, the method includes a step of generating respective isochrones relative to the candidate locations of the plurality of candidate cells based on the delivery time threshold indicated in the location planning request. Yet still further, the method includes a step of determining respective isochrone scores for the generated isochrones based at least on data indicating a past volume of sales in the isochrone. And still further, the method includes a step of selecting, based on the respective isochrone scores of the candidate locations, a subset of the candidate locations as a recommended set of locations for warehouses to cover the geographic region indicated in the location planning request. Finally, the method includes a step of transmitting a notification indicating the recommended set of locations to the user device.

### BRIEF DESCRIPTION OF THE DRAWINGS

FIG. 1 illustrates an example system environment for an online concierge system, in accordance with one or more illustrative embodiments.

FIG. 2 illustrates an example system architecture for an online concierge system, in accordance with one or more illustrative embodiments.

FIG. 3 is a block diagram of a location planning module of the online concierge system of FIG. 2, in accordance with one or more illustrative embodiments.

FIG. 4 illustrates a plurality of isochrones computed for candidate locations on a map of a geographic region included in a location planning request, in accordance with one or more illustrative embodiments.

FIG. 5 is a flowchart of a method for recommending a set of locations for setting up warehouses in response to a location planning request, in accordance with one or more illustrative embodiments.

### DETAILED DESCRIPTION

In one or more embodiments, minimizing the number of warehouses required to service a particular geographic area while providing ultrafast delivery services may involve a system dividing the geographic region into zones based on geographic size (e.g., measured in square miles) and identifying respective warehouse locations in the zones. That is, for example, the system may identify warehouse locations such that the locations can collectively service the whole geographic region, and each warehouse location is responsible for servicing its corresponding geographic zone defined by distance (e.g., each warehouse handles deliveries in a 5-mile radius of the warehouse). However, such a system leads to multiple inefficiencies.

First, the system gives equal weight to sparsely populated zones (or zones where the order delivery system does not have many customers) that may not have enough customer demand to justify the investment required to setup a warehouse location in that zone. Second, since the system sets up warehouse locations based on radius or distance from the warehouse location to the customer, the system does not account for various other factors that may affect the amount of time it takes for a picker to fill the order and deliver it to the customer's location (e.g., order volume handled by the warehouse location, vehicular traffic, inbound/outbound logistics, delivery mechanism employed (e.g., bike delivery, car delivery, public transport delivery, walking delivery, and the like)). To account for these other factors to optimize location placement, the system may need vast amounts of data and be able to analyze and make inferences from the data.

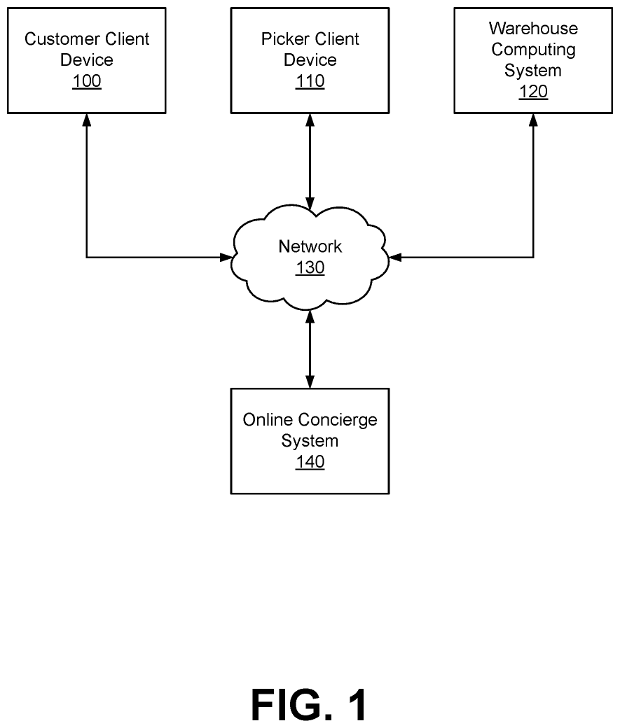

Figure (FIG.) 1 illustrates an example system environment for an online concierge system 140, in accordance with some embodiments. The system environment illustrated in FIG. 1 includes a customer client device 100, a picker client device 110, a warehouse computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and warehouses (e.g., retailers) may be generically referred to as “users” of the online concierge system 140. Further, devices of the customers, pickers, and warehouses, or devices associated with the online concierge system 140, may be generically referred to as “user devices.” Additionally, while one customer client device 100, picker client device 110, and warehouse computing system 120 are illustrated in FIG. 1, any number of customers, pickers, and warehouses may interact with the online concierge system 140. As such, there may be more than one customer client device 100, picker client device 110, or warehouse computing system 120.

The customer client device 100 is a client device through which a customer may interact with the picker client device 110, the warehouse computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item”, as used herein, means a good or product that can be provided to the customer through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding, or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the warehouse computing system 120, or the online concierge system 140. The picker device 100 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a warehouse. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same warehouse location. The collection interface further presents instructions that the customer may have included related to the collection of items in the order. Additionally, the collection interface may present a location of each item in the warehouse location and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the warehouse location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the warehouse location (e.g., retail store, fulfillment center, dark store, portable location, and the like) to the delivery location. Where a picker is servicing more than one order, the picker client device 110 identifies which items should be delivered to which delivery location. The picker client device 110 may provide navigation instructions from the warehouse location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the warehouse location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In some embodiments, the picker is a single person who collects items for an order from a warehouse location and delivers the order to the delivery location for the order. Alternatively, more than one person may serve the role as a picker for an order. For example, multiple people may collect the items at the warehouse location for a single order. Similarly, the person who delivers an order to its delivery location may be different from the person or people who collected the items from the warehouse location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a warehouse location for an order and an autonomous vehicle may deliver an order to a customer from a warehouse location.

The warehouse computing system 120 is a computing system operated by a warehouse that interacts with the online concierge system 140. As used herein, a “warehouse” is an entity that operates a “warehouse location,” which is a store, retailer, fulfillment center, dark store, or other building from which a picker can collect items. The warehouse computing system 120 stores and provides item data to the online concierge system 140 and may regularly update the online concierge system 140 with updated item data. For example, the warehouse computing system 120 may provide item data indicating which items are available at a warehouse location and the quantities of those items. Additionally, the warehouse computing system 120 may transmit updated item data to the online concierge system 140 when an item is no longer available at the warehouse location. Additionally, the warehouse computing system 120 may provide the online concierge system 140 with updated item prices, sales, or availabilities. Additionally, the warehouse computing system 120 may receive payment information from the online concierge system 140 for orders serviced by the online concierge system 140. Alternatively, the warehouse computing system 120 may provide payment to the online concierge system 140 for some portion of the overall cost of a user's order (e.g., as a commission).

The customer client device 100, the picker client device 110, the warehouse computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a warehouse. The online concierge system 140 receives orders from customer client devices 100 through the network 130. The online concierge system 140 selects a picker to service the customer's order and transmits the order to a picker client device 110 associated with the picker. The picker collects the ordered items from a warehouse location and delivers the ordered items to the customer. The online concierge system 140 may charge a customer for the order and provides portions of the payment from the customer to the picker and the warehouse.

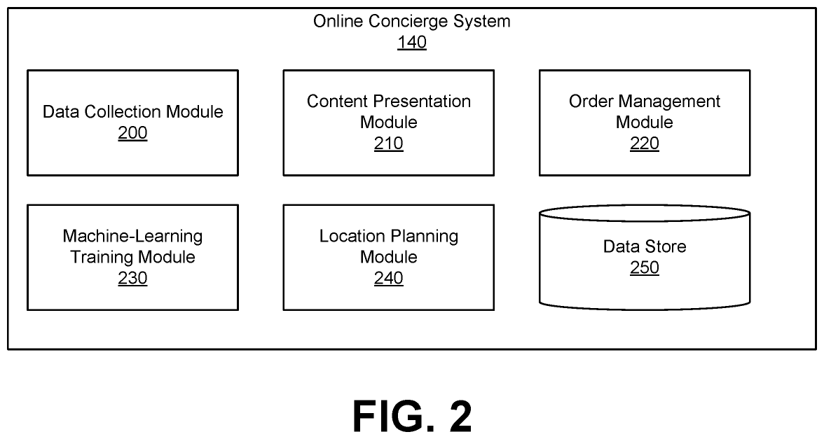

As an example, the online concierge system 140 may allow a customer to order groceries from a grocery store. The customer's order may specify which groceries they want delivered from the grocery store and the quantities of each of the groceries. The customer's client device 100 transmits the customer's order to the online concierge system 140 and the online concierge system 140 selects a picker to travel to the grocery store location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, a location planning module 240, and a data store 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 250. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default warehouse/warehouse location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a warehouse location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item if they exist. For example, age-restricted items such as alcohol and tobacco are flagged accordingly in the item data. Item data may also include information that is useful for predicting the availability of items in retailer locations. For example, for each item-warehouse combination (a particular item at a particular warehouse), the item data may include a time that the item was last found, a time that the item was last not found (a picker looked for the item but could not find it), the rate at which the item is found, or the popularity of the item. The data collection module 200 may collect item data from a warehouse computing system 120, a picker client device 110, or the customer client device 100.

Item data for an item may indicate an item category to which the item belongs. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which warehouses the picker has collected items at, or the picker's previous shopping history. Additionally, the picker data may include preferences expressed by the picker, such as their preferred warehouse locations to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a warehouse location from which the customer wants the ordered items collected, or a timeframe (e.g., delivery time threshold) within which the customer wants the order delivered. Order data may further include information describing how the order was serviced, such as which picker serviced the order, when the order was delivered, the warehouse location the order was picked up from, time duration from order pickup to delivery, actual travel time of the picker from the warehouse location to the delivery location, a rating that the customer gave the delivery of the order, and the like.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The order management module 220 manages orders for items from customers. The order management module 220 receives orders from customer client devices 100 and assigns the orders to pickers for service based on picker data. For example, the order management module 220 assigns an order to a picker based on the picker's location and the location of the warehouse (e.g., a warehouse whose location is selected by the location planning module 240) from which the ordered items are to be collected. The order management module 220 may also assign an order to a picker based on a delivery time threshold associated with the order (e.g., 15-minute delivery, 30-minute delivery, 2-hour delivery, and the like), how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the warehouse location associated with the order. If the order includes items to collect from multiple warehouse locations, the order management module 220 identifies the warehouse locations to the picker and may also specify a sequence in which the picker should visit the warehouse locations.

The order management module 220 may track the location of the picker through the picker client device 110 to determine when the picker arrives at the warehouse location. When the picker arrives at the warehouse location, the order management module 220 transmits the order to the picker client device 110 for display to the picker. As the picker uses the picker client device 110 to collect items at the warehouse location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the warehouse location to the delivery location, or to a subsequent warehouse location for further item collection. The order management module 220 tracks the location of the picker as the picker travels to the delivery location for an order and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers.

Each machine-learning model includes a set of parameters. A set of parameters for a machine-learning model are parameters that the machine-learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include customer data, picker data, item data, or order data. In some cases, the training examples also include a label which represents an expected output of the machine-learning model. In these cases, the machine-learning model is trained by comparing its output from input data of a training example to the label for the training example.

The machine-learning training module 230 may apply an iterative process to train a machine-learning model whereby the machine-learning training module 230 trains the machine-learning model on each of the set of training examples. To train a machine-learning model based on a training example, the machine-learning training module 230 applies the machine-learning model to the input data in the training example to generate an output. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross-entropy loss function. The machine-learning training module 230 updates the set of parameters for the machine-learning model based on the score generated by the loss function. For example, the machine-learning module 230 may apply gradient descent to update the set of parameters.

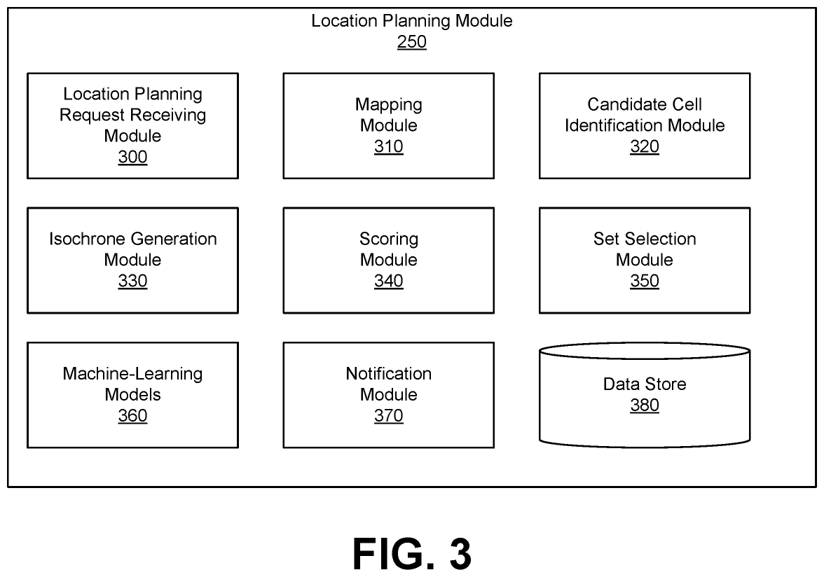

The location planning module 240 recommends a set of locations for setting up new warehouses in response to a location planning request. The online concierge system 140 may provide delivery services at different delivery speeds to customers. For example, in certain regions where there is enough demand and available infrastructure and logistical support, in addition to providing the “normal” delivery service with “normal” delivery times (e.g., several hours to one or more days), the online concierge system 140 may offer to customers one or more ultrafast delivery services where delivery is guaranteed within a predetermined time period (e.g., 15-minute, 30-minute or 2-hour delivery). To provide such fast delivery service(s) in a particular geographic region (e.g., a particular city or town), the location planning module 240 is configured to identify locations where the warehouses should be setup (and a number of such locations), so that the fast delivery service can be offered in the particular geographic region while maintaining profitability and high customer satisfaction. Details of the location planning module are provided below in connection with FIG. 3

The data store 250 stores data used by the online concierge system 140. For example, the data store 250 stores customer data, item data, order data, and picker data for use by the online concierge system 140. The data store 250 also stores trained machine-learning models trained by the machine-learning training module 230. For example, the data store 250 may store the set of parameters for a trained machine-learning model on one or more non-transitory, computer-readable media. The data store 250 uses computer-readable media to store data and may use databases to organize the stored data.

FIG. 3 is a block diagram of a location planning module of the online concierge system of FIG. 2, in accordance with one or more illustrative embodiments. The location planning module 240 illustrated in FIG. 2 includes a location planning request receiving module 300, a mapping module 310, a candidate cell identification module 320, an isochrone generation module 330, a scoring module 340, a set selection module 350, one or more machine-learning models 360, a notification module 370, and a data store 380. Alternative embodiments may include more, fewer, or different components from those illustrated in FIG. 3, and the functionality of each component may be divided between the components differently from the description below. Additionally, each component may perform their respective functionalities in response to a request from a human, or automatically without human intervention.

The location planning request receiving module 300 receives a location planning request from a user device. The user device may be a device associated with the customer client device 100, the picker client device 110, the warehouse computing system 120, or the online concierge system 140. For example, the user device is a device of a user of a real estate team of the online concierge system 140. The location planning request includes an indication of the geographic region, a delivery time threshold, and information regarding the items or item categories (e.g., groceries) deliverable under the service. The geographic region may be any region where the online concierge system 140 is currently providing delivery services or may be a region corresponding to a new market where the online concierge system 140 plans to provide delivery services. The delivery time threshold may indicate a predetermined time period (e.g., 15 minutes, 30 minutes, 2 hours) within which delivery of an order is being offered under the service.

The location planning request may include additional data. For example, the location planning request may specify warehouse characteristics. The warehouse characteristics may specify the minimum size and/or maximum size of each warehouse location necessary as per the objectives of the location planning request, the budget for acquiring, maintaining, and operating the warehouse location, and the like. For example, the user of the real estate team of the online concierge system 140 may be conducting research on providing 15-minute delivery services for certain grocery items to customers located in the Manhattan borough of New York City and may want to determine the number of warehouses (e.g., dark stores or fulfillment centers) and the location of each warehouse necessary for providing such a service.

The mapping module 310 accesses a map of the geographic region specified in the location planning request received by the location planning request receiving module 300. For example, the data store 380 may store detailed map data for a plurality of different geographic regions and the mapping module 310 accesses a map of the geographic region specified in the location planning request.

The mapping module 310 may further divide the geographic region into a plurality of cells (e.g., blocks, subunits). For example, the mapping module 310 may create or overlay a grid on top of the map of the geographic region, the grid defining a plurality of cells. In some embodiments, each cell may have dimensions within a range of 100 meters to 1000 meters. For example, each cell may be a square and each side of the square may be 100 meters long. Other embodiments of the mapping module 310 may divide the geographic region using cartographical indicators, i.e., commonly, conventionally, administratively, or legally agreed upon indicators of bounded areas on a land surface. For example, in case the geographic region includes a downtown metro area, mapping module 310 may divide (at least a portion of) the geographic region based on city blocks.

The candidate cell identification module 320 identifies a plurality of candidate cells from among the plurality of cells into which the geographic region is divided by the mapping module 310. The candidate cells may be cells, each of which includes a candidate location for setting up a warehouse. To determine for each of the plurality of cells, whether the cell is a candidate cell, the candidate cell identification module 320 may access data indicating predetermined cell characteristics associated with the cell. The predetermined cell characteristics of the cell may include different types of data regarding the cell like geographic or map data (e.g., whether (a part or a whole of) the cell is covered by a lake, an airport, a public park, a river, and the like), demographic or population data of the cell, zoning data associated with the cell (e.g., whether setting up a commercial warehouse is legally permitted in the cell), and the like. Data regarding the predetermined cell characteristics of the plurality of cells may be accessed from data store 380 and/or from an external data source.

Based on the data regarding the predetermined cell characteristics of the plurality of cells, the candidate cell identification module 320 may filter out from among the plurality of cells, cells that cannot be selected as the candidate cells. For example, a given cell may entirely (or significantly) be covered by a lake or a public park, and since such a cell cannot be a place where a warehouse location may be setup, the candidate cell identification module 320 may remove such a cell from the plurality of cells from which the candidate cells are to be selected or identified. As another example, the candidate cell identification module 320 may remove certain cells from the plurality of cells based on zoning law data identifying the certain cells as areas where commercial warehouses are not legally permitted. Thus, by accessing the predetermined cell characteristics associated with the cell, the candidate cell identification module 320 may determine whether the cell may be identified as a candidate cell.

Further, in determining for each of the plurality of cells, whether the cell is a candidate cell, the candidate cell identification module 320 may access data from other or external data sources. For example, the candidate cell identification module 320 may access a database listing a plurality of available warehouse locations (e.g., new viable locations for rent or sale, existing stores, or locations of a particular retail chain) in the geographic region. The database may be stored in the data store 380 or may be stored in another third-party data store external to the online concierge system 140. The database listing the plurality of available warehouse locations in the geographic region may include information regarding the available warehouse locations like the size (e.g., square feet), the address, the price, and the like. Based on the information, and for each cell (other than the cells removed based on the predetermined cell characteristics), the candidate cell identification module 320 may determine whether the cell can be identified as a candidate cell. For example, if based on the information, the candidate cell identification module 320 determines that one or more warehouse locations whose geographic locations fall within boundaries of the cell are available, the candidate cell identification module 320 may determine that the cell can be identified as a candidate cell. In determining that the cell can be identified as a candidate cell, the candidate cell identification module 320 may determine whether at least one of the one or more available warehouse locations in the cell meet the warehouse characteristics (e.g., available location(s) meet budget or size requirements specified by the warehouse characteristics). Thus, based on the data regarding the predetermined cell characteristics, the data from other sources, and the data regarding the warehouse characteristics, the candidate cell identification module 320 determines for each cell whether it can be identified as a candidate cell.

For each identified candidate cell, the candidate cell identification module 320 identifies a candidate location in the candidate cell. The candidate cell identification module 320 may determine the candidate location based on the warehouse characteristics of the location planning request. For example, for each candidate cell, the candidate cell identification module 320 may determine a subset of warehouse locations from among the plurality of available warehouse locations from the database that correspond to the cell. The candidate cell identification module 320 may determine as the subset, those warehouse locations whose geographic locations fall within boundaries of the cell. The candidate cell identification module 320 may further identify from among the subset of warehouse locations located in the cell, a candidate location for the candidate cell based on the determined warehouse characteristics. For example, the candidate cell identification module 320 may identify as the candidate location for the candidate cell, a location of one of the subset of the available warehouse locations based on the determined warehouse characteristics. For example, if there are more than one warehouse locations available in the current candidate cell that meet the warehouse characteristics, and the candidate cell identification module 320 may be configured to identify (e.g., based on price, size, price per square foot, and the like) the location of one of the available warehouse locations as the candidate location for the candidate cell.

In some embodiments, the candidate cell identification module 320 selects a center of the candidate cell as the candidate location, and a corresponding isochrone is centered around the center of the candidate cell. If a candidate location is at a point other than the center of the candidate cell (e.g., based on an available/viable warehouse location), the isochrone corresponding to the candidate cell is centered around that location. In some embodiments, each candidate cell identified by the candidate cell identification module 320 may include one candidate location (e.g., center of the cell, or another selected location within the cell).

The isochrone generation module 330 generates respective isochrones relative to the candidate locations of the plurality of candidate cells based on the delivery time threshold indicated in the location planning request. For each candidate cell, the isochrone generation module 330 generates the isochrone around the candidate location of the cell. Each isochrone depicts the area within the geographic region that is accessible from the corresponding candidate location within the delivery time threshold (e.g., 15 minutes). That is, each isochrone represents a delivery radius/frontier measured in travel time around the candidate location.

In some embodiments, each isochrone may be generated by a machine-learning model 360 that is trained to output predicted travel times between any two locations in the geographic region (e.g., predict delivery times from prospective points corresponding to candidate locations to orders all around the location). For example, the machine-learning model 360 may be trained by the machine-learning training module 230 based on the order data collected by the data collection module 200. The order data may include historical data of a plurality of orders corresponding to the geographic region, and for each order, the warehouse location, the delivery location, and point-to-point actual travel time. The machine-learning model 360 may further be trained using external data (e.g., from a third-party API for mapping and location intelligence) to obtain more accurate delivery time predictions. The isochrones generated by the isochrone generation module 330 based on the input delivery time threshold may represent isochrones at a quantile (e.g., 70-90%) higher than a mean or median. That is, in outputting the travel time predictions, the machine-learning model 360 is configured to take into consideration variances like traffic and delivery profile or mode of delivery (e.g., delivery vehicle types like car or bike determined based on geographic location), so that at least a predetermined threshold (e.g., 70-90%; higher than mean or median) of the deliveries within the frontier defined by the isochrone and from the corresponding candidate location are completed within the threshold time period.

For example, the historical data of the plurality of orders corresponding to the geographic region may include, for each order, the mode of delivery (e.g., walking delivery, bike delivery, e-bike delivery, car delivery) used and corresponding point-to-point actual travel time for the order. And the machine-learning model 360 may be trained using the historical data so that each generated isochrone includes multiple delivery profiles corresponding to one or more possible modes of delivery. For example, based on the output from the machine-learning model 360, the isochrone generation module 330 may disqualify certain modes of delivery from a given isochrone where a particular mode of delivery is prohibited (e.g., interstate highway delivery doesn't allow for bicycles) or where corresponding historical data does not include order data of orders having the particular mode of delivery.

The training data set for the machine-learning model 360 to predict travel times may further include data regarding a profile of the picker assigned to a particular order, geographic features within the candidate cell, and other features within the candidate cell like density of traffic lights, stop signs, pedestrian traffic, pedestrian road crossings, dedicated bike lanes, and the like. In addition, the training data set for the machine-learning model 360 to predict travel times may include data regarding the weather, anticipated future public transportation infrastructure, and the like. The training set of data may thus be a vector of multiple sources of data as labeled with travel time, and the predictions may be based on the multiple sources of data, to thereby output more accurate travel time predictions using one or more appropriate selected mode(s) of delivery, and thereby generate more accurate delivery radius/frontier predictions for the isochrones measured in travel time around the candidate locations. The machine-learning model 360 may be updated periodically or aperiodically to maintain accuracy of the travel time predictions and corresponding generated isochrone frontiers by retraining the model using updated training data.

Scoring module 340 determines respective isochrone scores for the generated isochrones. In some embodiments, the scoring module 340 determines the respective isochrone scores for each isochrone based on the order data from the data collection module 200, where the order data indicates a past volume of sales in the isochrone. The past sales volume (e.g., total sales, total revenue, total number of orders, and the like) inside each isochrone may be a revenue/sales score for the isochrone, and, hence, for the corresponding candidate location. The past sales volume for the isochrone may be a proxy for expected traffic or order score if a warehouse were built at the corresponding candidate location to service the delivery area represented by the isochrone (e.g., assigning a higher score to an isochrone having a higher past sales volume).

In addition, or in the alternative, the scoring module 340 may determine the respective isochrone scores for each isochrone based on forecast data indicating a forecast of future sales volume in the isochrone (e.g., higher score for an isochrone whose total volume of sales is expected to grow), based on demographic data or population data of the isochrone (e.g., higher score for an isochrone whose population is predicted to grow), and the like. In some embodiments, a forecasting machine-learning model 360 may be trained to output the forecast data indicating the forecast of future sales volume in each isochrone. For example, the forecasting machine-learning model 360 may be trained using as input the order data from the data collection module 200, as well as data from external data sources (e.g., demographic data targeting new types of customers, population growth data, average household income data, online activity data indicating users searching for instant delivery options in a particular area, and the like). For example, the forecasting machine-learning model 360 may be trained to find correlations over time between the order data from the data collection module 200 in different regions, and other data like demographic data, population data, online activity data, household income data, and the like, for the corresponding region. And the forecasting machine-learning model 360 may be trained to output a higher score for a given isochrone if the corresponding data over time from the isochrone indicates that the number of orders from the region corresponding to the given isochrone is likely to be higher or likely to increase over time. The forecasting machine-learning model 360 may be updated periodically or aperiodically to maintain accuracy of the forecast data by retraining the model using updated order data and updated data from the external data sources.

The forecasting machine-learning model 360 may further be trained to predict what the volume of sales is expected to be in the isochrone in the future, indicating future profitability (predicting future demand/sales) of a warehouse location related to the isochrone. The forecast data may also include data indicating a profitability value for each candidate location based on data regarding the marginal cost of setting up the warehouse in a given location relative to the expected sales volume at that location. Based on the forecast data output from the forecasting machine-learning model, the respective isochrone scores for the isochrones may be further updated/refined. The isochrone scores may also be updated/refined by the scoring module 340 based on the data regarding the profitability values.

The set selection module 350 selects, based on the respective isochrone scores of the candidate locations determined by the scoring module 340, a subset of the candidate locations as a recommended set of locations for warehouses to cover the geographic region indicated in the location planning request. The set selection module 350 selects the subset of the candidate locations so that isochrones with the highest isochrone scores are selected in the subset and so that an overlap between isochrones respectively corresponding to any two candidate locations included in the subset of candidate locations is less than a threshold overlap value. For example, the set selection module 350 may determine that the overlap between two isochrones is less than the threshold overlap value when a number of customers being double-counted in the two isochrones to determine the respective isochrone scores is less than a predetermined number.

In one or more embodiments, the set selection module 350 may select at least a predetermined number (e.g., 5) of the isochrones, where the selected isochrones maximize the isochrone scores while minimizing overlap among the selected isochrones. In other embodiments, the isochrone selection may not be limited to a ranking algorithm but may involve optimization models such as set covering, where a number of isochrones to be selected is not determined in advance.

For example, the ranking algorithm-based isochrone selection may involve the isochrones being iteratively selected such that after selecting the first isochrone with the highest score, the set selection module 350 may iteratively operate to select additional isochrone(s) one-at-a-time, where each additional selected isochrone maximizes the isochrone score while minimizing overlap with the other selected isochrones to be less than a threshold overlap value, and where a profitability value of each additional isochrone is higher than a threshold profitability value (e.g., selecting the next isochrone is economically justified because it will be profitable). The set selection module 350 may thus iteratively determine the number of the candidate locations to be selected in the subset based on the profitability value successively determined for each additional candidate location selected to be included in the subset. That is, after selecting a first one of the candidate locations whose isochrone score is the highest, the set selection module 350 may select one or more additional candidate locations from among the candidate locations other than the first candidate location based on, for each selected additional candidate location: (i) the isochrone score of the additional candidate location being the highest; (ii) an overlap value indicating an amount of overlap between the additional candidate location and other candidate locations included in the recommended set of locations being less than a threshold overlap value; and (iii) a profitability value indicating profitability of the additional candidate location being higher than a threshold profitability value, where the profitability value is determined based on the warehouse characteristics of the location planning request, and the isochrone score of the additional candidate location. The set selection module 350 thus finds a set of locations that collectively cover as much of the geographic region as possible, are as mutually exclusive as possible, and that maintain at least a predetermined threshold profitability value for each additional warehouse location.

In other embodiments, the set selection module 350 may implement the optimization model such as set covering to select, collectively and all together, the set of isochrones having the highest isochrone scores, that cover as much of the geographic region as possible, are as mutually exclusive as possible, and that maintain at least the predetermined threshold profitability value for each warehouse location.

The notification module 370 may transmit a notification indicating the recommended set of locations selected by the set selection module 350 to the user device. For example, the notification may cause a display of the user device to display a user interface including a map of the geographic region, where the user interface shows a map of the selected geographic region and the one or more isochrones corresponding to the recommended set of locations. The notification module 370 may cause transmission of one or more commands directing the user device to display the notification. The one or more commands may cause the user device to display the notification on a display screen. As another example, the one or more commands may cause the user device to display a dynamic map interface guiding the user to a selected one of the recommended set of locations.

The data store 380 stores data used by the different modules of the location planning module 250. For example, the data store 380 stores the trained machine-learning models 360 trained by the machine-learning training module 230. The data store 380 may also store data received from external data sources like data listing available warehouse locations in the geographic region. In some embodiments 370, may further be configured to utilize the information regarding the recommended set of locations selected by the set selection module 350 to generate marketing data for out of home marketing to capture maximum demand.

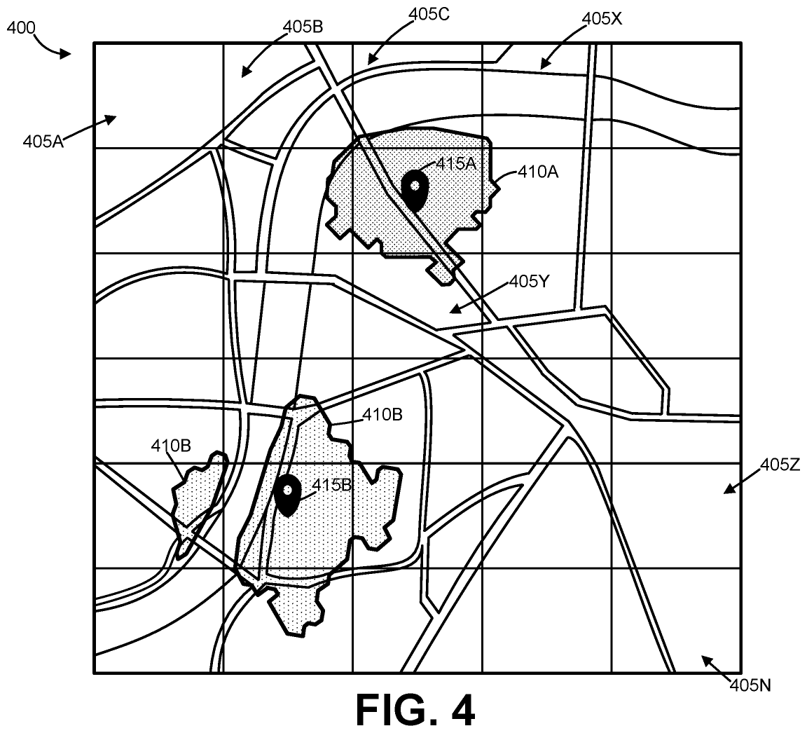

FIG. 4 illustrates a plurality of isochrones computed for candidate locations on a map of a geographic region included in a location planning request, in accordance with one or more illustrative embodiments. The mapping module 310 may create a grid 400 and overlay the grid 400 on the geographic region indicated in the location planning request. The mapping module 310 may divide the grid 400 of the geographic region into a plurality of cells 405 (e.g., 405A, 405B, . . . , 405N). The candidate cell identification module 320 may identify from among the plurality of cells 405, candidate cells for which isochrones are to be generated based on the predetermined cell characteristics, the warehouse characteristics, and other data.

For example, in the illustrative map in FIG. 4, the candidate cell identification module 320 may identify all of the cells 405 except cells 405X and 405Y as candidate cells based on data regarding the predetermined cell characteristics, the warehouse characteristics, and data from an external data source. For example, the candidate cell identification module 320 may determine that at least a predetermined threshold area (e.g., more than 50%) of the cell 405X is covered by a river (and hence, it is not an ideal location for setting up a warehouse). As a result, the candidate cell identification module 320 may exclude cell 405X from the plurality of candidate cells. As another example, the candidate cell identification module 320 may determine based on data from an external data source (e.g., available warehouse location data) that the cell 405Y does not include a warehouse location that meets the warehouse characteristics of the warehouse location as per the location planning request. And therefore, the candidate cell identification module 320 may exclude the cell 405Y from the plurality of candidate cells.

For the remaining cells 405 identified as candidate cells, the isochrone generation module 330 may respectively generate isochrones 410 (e.g., 410A, 410B) around the candidate location 415 (e.g., 415A, 415B) of the cell 405. Each isochrone 410 depicts the area within the geographic region that is accessible from the corresponding candidate location 415 within the delivery time threshold (e.g., 15 minutes) specified in the location planning request. Although the isochrones 410 in FIG. 4 depict substantially the center of the corresponding cell 405 as the point relative to which the isochrone is generated, as explained previously, this may not necessarily be the case. For example, the candidate location 415 for each cell 405 may be based on an actual available warehouse location in the cell 405, and in this case, the isochrone 410 will be generated relative to a point of the cell corresponding to the actual available warehouse location.

For ease of illustration, FIG. 4 only shows two isochrones 410. But as explained previously, the isochrone generation module 330 generates isochrones for each candidate cell based on the corresponding candidate location. The scoring module 340 then assigns the isochrone scores to each of the isochrones 410 based on, e.g., the sales volume in the area covered by the isochrone 410. The set selection module 350 then selects a set of isochrones from the plurality of isochrones generated for the plurality of candidate cells based on the calculated isochrone scores, so that the isochrone scores for the selected isochrones are maximized, while an overlap between the isochrones selected in the set is minimized (e.g., to prevent double counting of customers based on which the isochrone scores are calculated). Further, the set selection module 350 selects the set of isochrones so that the geographic region (e.g., area of the grid 400) can be covered with the isochrones selected in the set (thereby ensuring that any point in the geographic region can be reached from a corresponding candidate location within the delivery time threshold), while maintaining predetermined minimum profitability values for each additional selected isochrone. For example, an isochrone corresponding to a candidate location in the cell 405Z may ensure coverage for orders originating in the region defined by cell 405Z and neighboring cells. However, the profitability value computed for the isochrone corresponding to the cell 405Z may be less than the threshold, indicating that the marginal benefit of setting up a warehouse in cell 405Z is outweighed by the marginal cost. And in this case, the set selection module 350 may not include the candidate location corresponding to the cell 405Z in the recommended set of locations for warehouses, even if the region defined by the cell 405Z and neighboring cells will remain uncovered by an isochrone (and therefore, corresponding orders may not be serviceable within the specified delivery time threshold).

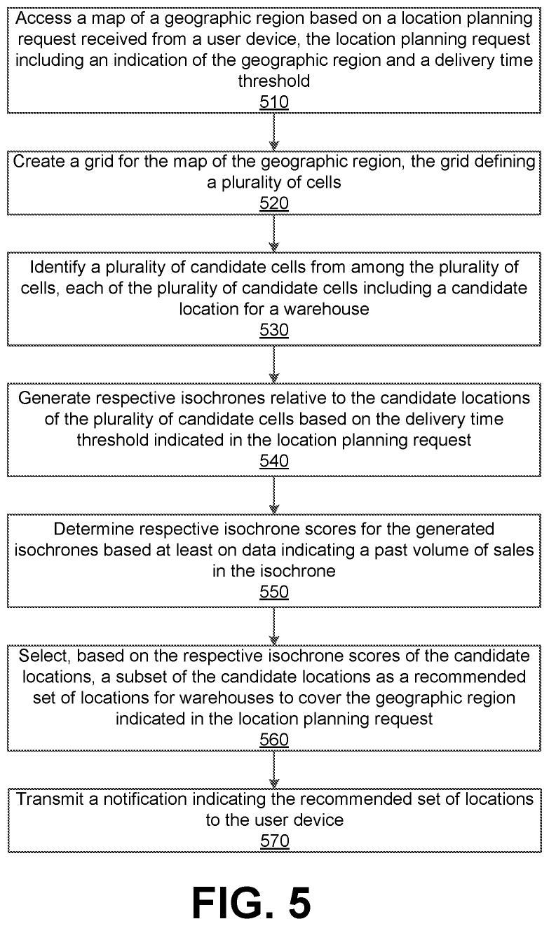

FIG. 5 is a flowchart of a method for recommending a set of locations for setting up warehouses in response to a location planning request, in accordance with one or more illustrative embodiments. Alternative embodiments may include more, fewer, or different steps from those illustrated in FIG. 5, and the steps may be performed in a different order from that illustrated in FIG. 5. These steps may be performed by an online concierge system (e.g., online concierge system 140). Additionally, each of these steps may be performed automatically by the online concierge system without human intervention.

The mapping module 310 may access 510 a map of a geographic region based on a location planning request received from a user device. The location planning request may include an indication of the geographic region and a delivery time threshold (e.g., 15 minutes). The mapping module 310 may further create 520 a grid (FIG. 4) for the map of the geographic region, the grid defining a plurality of cells.

The candidate cell identification module 320 may identify 530 a plurality of candidate cells from among the plurality of cells, each of the plurality of candidate cells including a candidate location for a warehouse. The isochrone generation module 330 may generate 540 respective isochrones relative to the candidate locations of the plurality of candidate cells based on the delivery time threshold indicated in the location planning request.

The scoring module 340 may determine 550 respective isochrone scores for the generated isochrones based at least on data indicating a past volume of sales in the isochrone. The set selection module 350 may select 560, based on the respective isochrone scores of the candidate locations, a subset of the candidate locations as a recommended set of locations for warehouses to cover the geographic region indicated in the location planning request. And the notification module 370 may transmit 570 a notification indicating the recommended set of locations to the user device.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A computer-implemented method comprising, at one or more processors of a computer system:
accessing a map of a geographic region based on a location planning request received from a user device, the location planning request including an indication of the geographic region and a delivery time threshold;
creating a grid for the map of the geographic region, the grid defining a plurality of cells;
identifying a plurality of candidate cells from among the plurality of cells, each of the plurality of candidate cells including a candidate location for a warehouse;
generating respective isochrones relative to the candidate locations of the plurality of candidate cells based on the delivery time threshold indicated in the location planning request;
determining respective isochrone scores for the generated isochrones based at least on data indicating a past volume of sales in the isochrone;
selecting, based on the respective isochrone scores of the candidate locations, a subset of the candidate locations as a recommended set of locations for warehouses to cover the geographic region indicated in the location planning request; and
transmitting a notification indicating the recommended set of locations to the user device.

2. The computer-implemented method of claim 1, further comprising:
receiving the location planning request from the user device; and
transmitting one or more commands directing the user device to display the notification, wherein the one or more commands cause the user device to display the notification on a display.

3. The computer-implemented method of claim 2, wherein the one or more commands further cause the user device to display a dynamic map interface guiding a user to a selected one of the recommended set of locations.

4. The computer-implemented method of claim 1, wherein determining the respective isochrone scores comprises assigning a first isochrone score to a first isochrone having a higher past volume of sales than a past volume of sales in a second isochrone, the first isochrone score being higher than a second isochrone score assigned to the second isochrone.

5. The computer-implemented method of claim 1, wherein for each of the plurality of candidate cells, a center of the candidate cell is selected as the candidate location, and wherein a corresponding isochrone is centered around the center of the candidate cell.

6. The computer-implemented method of claim 1, further comprising:
determining warehouse characteristics based on the location planning request;
wherein identifying the plurality of candidate cells from among the plurality of cells comprises, for each of the plurality of cells:
accessing predetermined cell characteristics associated with the cell;
determining whether the predetermined cell characteristics satisfy the warehouse characteristics; and
in response to determining that the predetermined cell characteristics satisfy the warehouse characteristics, identifying the cell as a candidate cell;
wherein the cell is not identified as the candidate cell in response to determining that the predetermined cell characteristics do not satisfy the warehouse characteristics.

7. The computer-implemented method of claim 6, further comprising, for each of the plurality of candidate cells:
accessing a database listing a plurality of available warehouse locations in the geographic region;
determining a subset of the plurality of available warehouse locations that correspond to the candidate cell; and
identifying as the candidate location for the candidate cell, one of the subset of the plurality of available warehouse locations based on the determined warehouse characteristics,
wherein an isochrone corresponding to the candidate cell is centered around the identified candidate location of the candidate cell.

8. The computer-implemented method of claim 1, wherein the respective isochrones are generated based on a first machine-learning model that is trained to output predicted travel times between any two locations in the geographic region, wherein training the first machine-learning model comprises:
accessing training data comprising data of a plurality of past orders corresponding to the geographic region, each past order including a warehouse location, a delivery location, and an actual travel time; and
training the first machine-learning model based on the training data and based on the delivery time threshold to predict, for each isochrone, a delivery frontier from a corresponding candidate location.

9. The computer-implemented method of claim 1, wherein the respective isochrone scores are determined further based on a second machine-learning model that is trained to output forecast data indicating a forecast of future sales volume in the isochrone, wherein training the second machine-learning model comprises:
accessing training data comprising order data over time of a plurality of orders corresponding to the geographic region and demographic data over time; and
training the second machine-learning model based on the training data to identify correlations over time based on the order data and the demographic data, wherein the forecast data is based on the identified correlations.

10. The computer-implemented method of claim 1, wherein the respective isochrone scores are determined further based on demographic data of the isochrone.

11. The computer-implemented method of claim 1, further comprising:
determining warehouse characteristics based on the location planning request;
wherein selecting the subset of the candidate locations as the recommended set of locations for warehouses comprises:
selecting a first one of the candidate locations having a highest isochrone score; and
selecting one or more additional candidate locations from among the candidate locations other than the first candidate location based on, for each selected additional candidate location: (i) the isochrone score of the additional candidate location being the highest; (ii) an overlap value indicating an amount of overlap between the additional candidate location and other candidate locations included in the recommended set of locations being less than a threshold overlap value; and (iii) a profitability value indicating profitability of the additional candidate location being higher than a threshold profitability value, wherein the profitability value is determined based on the warehouse characteristics of the location planning request, and the isochrone score of the additional candidate location.

12. The computer-implemented method of claim 1, wherein an overlap between isochrones respectively corresponding to any two candidate locations included in the subset of candidate locations is less than a threshold overlap value.

13. The computer-implemented method of claim 12, wherein the overlap between two isochrones is less than the threshold overlap value when a number of customers being double-counted in the two isochrones to determine the respective isochrone scores is less than a predetermined number.

14. The computer-implemented method of claim 1, wherein a number of the candidate locations selected in the subset is at least a predetermined number.

15. The computer-implemented method of claim 1, wherein a number of the candidate locations selected in the subset is determined based on a profitability value successively determined for each additional candidate location selected to be included in the subset.

16. A non-transitory computer-readable storage medium comprising instructions that, when executed by a processor, cause the processor to:
access a map of a geographic region based on a location planning request received from a user device, the location planning request including an indication of the geographic region and a delivery time threshold;
create a grid for the map of the geographic region, the grid defining a plurality of cells;
identify a plurality of candidate cells from among the plurality of cells, each of the plurality of candidate cells including a candidate location for a warehouse;
generate respective isochrones relative to the candidate locations of the plurality of candidate cells based on the delivery time threshold indicated in the location planning request;
determine respective isochrone scores for the generated isochrones based at least on data indicating a past volume of sales in the isochrone;
select, based on the respective isochrone scores of the candidate locations, a subset of the candidate locations as a recommended set of locations for warehouses to cover the geographic region indicated in the location planning request; and
transmit a notification indicating the recommended set of locations to the user device.

17. The non-transitory computer readable storage medium of claim 16, further comprising instructions that cause the processor to:
determine warehouse characteristics based on the location planning request;
wherein the instructions that cause the processor to identify the plurality of candidate cells from among the plurality of cells comprise instructions that cause the processor to, for each of the plurality of cells:
access predetermined cell characteristics associated with the cell; and
determine whether the predetermined cell characteristics satisfy the warehouse characteristics; and
in response to determining that the predetermined cell characteristics satisfy the warehouse characteristics, identify the cell as a candidate cell;
wherein the cell is not identified as the candidate cell in response to determining that the predetermined cell characteristics do not satisfy the warehouse characteristics.

18. The non-transitory computer readable storage medium of claim 17, further comprising instructions that cause the processor to, for each of the plurality of candidate cells:
access a database listing a plurality of available warehouse locations in the geographic region;
determine a subset of the plurality of available warehouse locations that correspond to the candidate cell; and
identify as the candidate location for the candidate cell, one of the subset of the plurality of available warehouse locations based on the determined warehouse characteristics,
wherein an isochrone corresponding to the candidate cell is centered around the identified candidate location of the candidate cell.

19. The non-transitory computer readable storage medium of claim 16, wherein the respective isochrones are generated based on a first machine-learning model that is trained to output predicted travel times between any two locations in the geographic region, wherein the non-transitory computer readable storage medium further comprises instructions that cause the processor to:
access training data comprising data of a plurality of past orders corresponding to the geographic region, each past order including a warehouse location, a delivery location, and an actual travel time; and
train the first machine-learning model based on the training data and based on the delivery time threshold to predict, for each isochrone, a delivery frontier from a corresponding candidate location.

20. An online concierge system comprising:
one or more hardware processors; and
memory operatively coupled to the one or more hardware processors, the memory comprising instructions that, when executed by the one or more hardware processors, cause the one or more hardware processors to:
access a map of a geographic region based on a location planning request received from a user device, the location planning request including an indication of the geographic region and a delivery time threshold;
create a grid for the map of the geographic region, the grid defining a plurality of cells;
identify a plurality of candidate cells from among the plurality of cells, each of the plurality of candidate cells including a candidate location for a warehouse;
generate respective isochrones relative to the candidate locations of the plurality of candidate cells based on the delivery time threshold indicated in the location planning request;
determine respective isochrone scores for the generated isochrones based at least on data indicating a past volume of sales in the isochrone;
select, based on the respective isochrone scores of the candidate locations, a subset of the candidate locations as a recommended set of locations for warehouses to cover the geographic region indicated in the location planning request; and
transmit a notification indicating the recommended set of locations to the user device.
